(19) United States
(12) Patent Application Publication
(10) Pub. No.: US 2023/0304933 A1
(43) Pub. Date: Sep. 28, 2023

(54) ANALYSIS DEVICE AND ANALYSIS METHOD

(71) Applicant: FUJIFILM Corporation, Tokyo (JP)

(72) Inventors: Yoshinobu Miura, kanagawa (JP); Yoshihiko Abe, Kanagawa (JP)

(73) Assignee: FUJIFILM Corporation, Tokyo (JP)

(21) Appl. No.: 18/184,840

(22) Filed: Mar. 16, 2023

(30) Foreign Application Priority Data
Mar. 22, 2022 (JP) 2022-046014

(51) Int. Cl. G01N 21/64

(52) U.S. Cl. CPC G01N 21/6428; G01N 21/6456; G01N 2021/8845

(57) ABSTRACT

An analysis device uses a single or a plurality of analysis chips having two regions of a first region, which has a reagent reacting with a substance to be tested, and a second region, which does not have the reagent. The analysis device includes a light source that irradiates the analysis chip with light, a photodetector that detects output light, which is output from the analysis chip, and that outputs a first detection signal corresponding to the output light from the first region and a second detection signal corresponding to the output light from the second region, and a processor that acquires the first detection signal and the second detection signal from the photodetector and that corrects the first detection signal with the second detection signal to derive a concentration of the substance to be tested included in the sample.

### CROSS REFERENCE TO RELATED APPLICATIONS

This application claims priority from Japanese Application No. 2022-046014, filed on Mar. 22, 2022, the entire disclosure of which is incorporated herein by reference.

### BACKGROUND

### 1. Technical Field

The present disclosure relates to an analysis device and an analysis method.

### 2. Related Art

In point-of-care testing (POCT), an analysis device is known which performs sample analysis, such as the measurement of the concentration of a substance to be tested included in a sample. A blood test is given as an example of the sample analysis. In the blood test, there is a device that measures the concentration of the substance to be tested included in blood. There is an increasing demand for shortening a measurement time and reducing the size of the device. In order to meet the demand, an analysis chip may be used to omit a pretreatment step such as the centrifugation of blood plasma or the like from whole blood. For example, JP2012-211782A discloses an analysis device which optically performs a blood test using an analysis chip comprising a development layer in which blood is developed as a sample and a reaction layer which has a reagent. The analysis device disclosed in JP2012-211782A comprises a first photodetector that detects reflected light from the analysis chip and a second photodetector that detects transmitted light from the analysis chip.

In a case in which the above-described analysis chip is used and the sample is instilled into the development layer of the analysis chip, the sample is developed in the development layer. In a case in which the sample reaches the reaction layer, the substance to be tested in the sample reacts with the reagent in the reaction layer to generate a reactant that develops a color. The analysis device disclosed in JP2012-211782A can measure the concentration of the substance to be tested in the sample by irradiating the reaction layer, in which the sample and the reagent react with each other, with detection light, which includes light having a wavelength absorbed by the reactant that develops a color, from a light source and acquiring a detection signal corresponding to the reflected light from the reaction layer.

### SUMMARY

However, since the sample developed in the analysis chip includes various substances other than the substance to be tested, the detection signal corresponding to the reflected light from the reaction layer in which the sample and the reagent react with each other may include, as noise, a signal caused by a substance that does not react with the reagent. Therefore, the analysis device disclosed in JP2012-211782A that acquires only the detection signal from the reaction layer has room for improvement in order to measure the concentration with high accuracy.

The technology of the present disclosure provides an analysis device and an analysis method that can measure a concentration of a substance to be tested in a sample with higher accuracy than that in the related art in a case in which the sample is analyzed using an analysis chip.

According to one aspect of the present disclosure, there is provided an analysis device that analyzes a sample including a substance to be tested and that uses a single or a plurality of analysis chips having two regions of a first region, which has a reagent reacting with the substance to be tested, and a second region, which does not have the reagent. The analysis device comprises: a light source that irradiates the analysis chip with light; a photodetector that detects output light, which is output from the analysis chip in a case in which the analysis chip is irradiated with the light, and that outputs a first detection signal corresponding to the output light from the first region and a second detection signal corresponding to the output light from the second region; and a processor that is configured to acquire the first detection signal and the second detection signal from the photodetector, and correct the first detection signal with the second detection signal to derive a concentration of the substance to be tested included in the sample.

In the analysis device according to the above-described aspect, two analysis chips of a first analysis chip having the first region and a second analysis chip having the second region may be used as the analysis chip.

In addition, in the analysis device according to the above-described aspect, each of the first analysis chip and the second analysis chip may include a carrier having a development layer in which the sample is developed and a reaction layer which is capable of holding the reagent and in which the reagent and the substance to be tested are capable of reacting with each other.

Further, the analysis device according to the above-described aspect may further comprise a loading unit on which the first analysis chip and the second analysis chip are selectively loaded.

Furthermore, in the analysis device according to the above-described aspect, the single analysis chip having the first region and the second region may be used as the analysis chip.

Moreover, in the analysis device according to the above-described aspect, the single analysis chip may include a development layer in which the sample is developed and a reaction layer which is capable of holding the reagent and in which the reagent and the substance to be tested are capable of reacting with each other, and the reaction layer may have a first reaction layer which corresponds to the first region having the reagent and a second reaction layer which corresponds to the second region that does not have the reagent and which is separate from the first reaction layer.

In addition, in the analysis device according to the above-described aspect, the development layer may have a first development layer which corresponds to the first region and a second development layer which corresponds to the second region and which is separate from the first development layer.

Further, in the analysis device according to the above-described aspect, the development layer may be a single development layer that is common to the first region and to the second region.

Furthermore, in the analysis device according to the above-described aspect, the output light may be light which has been emitted from the light source and reflected by the first region or the second region.

Moreover, in the analysis device according to the above-described aspect, the photodetector may be an image sensor that has an imaging surface in which a plurality of light-receiving elements are two-dimensionally arranged and that is capable of imaging the first region and outputting a first region image obtained by imaging the first region as the first detection signal, and the processor may be configured to identify a development region in which the sample has been developed in the first region on the basis of the first region image and correct the first detection signal according to the development region.

In addition, in the analysis device according to the above-described aspect, a wavelength range of light emitted from the light source to the first region may include a specific wavelength range that is determined according to at least one of the substance to be tested or the reagent.

Further, in the analysis device according to the above-described aspect, the light source may be capable of emitting light in a plurality of different wavelength ranges as the light in the specific wavelength range.

Furthermore, in the analysis device according to the above-described aspect, the reagent may be a dry reagent.

Moreover, in the analysis device according to the above-described aspect, the sample may be whole blood, and the substance to be tested may be a specific substance included in blood plasma or in blood serum.

According to another aspect of the present disclosure, there is provided an analysis method for analyzing a sample including a substance to be tested. A single or a plurality of analysis chips having two regions of a first region and a second region are used. The first region has a reagent reacting with the substance to be tested, and the second region does not have the reagent. The analysis method comprises: a step of irradiating the analysis chip with light from a light source; a step of detecting output light, which is output from the analysis chip in a case in which the analysis chip is irradiated with the light, with a photodetector and acquiring a first detection signal and a second detection signal output by the photodetector, the first detection signal corresponding to the output light from the first region, and the second detection signal corresponding to the output light from the second region; and a step of correcting the first detection signal with the second detection signal with a processor to derive a concentration of the substance to be tested included in the sample.

According to the technology of the present disclosure, it is possible to measure the concentration of a substance to be tested in a sample with higher accuracy than in the related art in a case in which the sample is analyzed using an analysis chip.

### BRIEF DESCRIPTION OF THE DRAWINGS

FIG. 1 is a schematic diagram illustrating an analysis device and an analysis method according to a first embodiment.

FIG. 2 is a diagram illustrating a configuration of a first analysis chip having a reagent.

FIG. 3 is a diagram illustrating a configuration of a second analysis chip that does not have the reagent.

FIG. 4 is a schematic diagram illustrating a configuration of a measurement unit of the analysis device.

FIG. 5 is a summary diagram illustrating a process of the analysis device.

FIG. 6 is a diagram illustrating a configuration of an analysis chip according to a second embodiment.

FIG. 7 is a diagram illustrating a configuration of an analysis chip according to a modification example of the second embodiment.

FIG. 8 is a diagram in a case in which an image sensor is used.

### DETAILED DESCRIPTION

Hereinafter, preferred embodiments of the invention will be described with reference to the drawings.

### First Embodiment

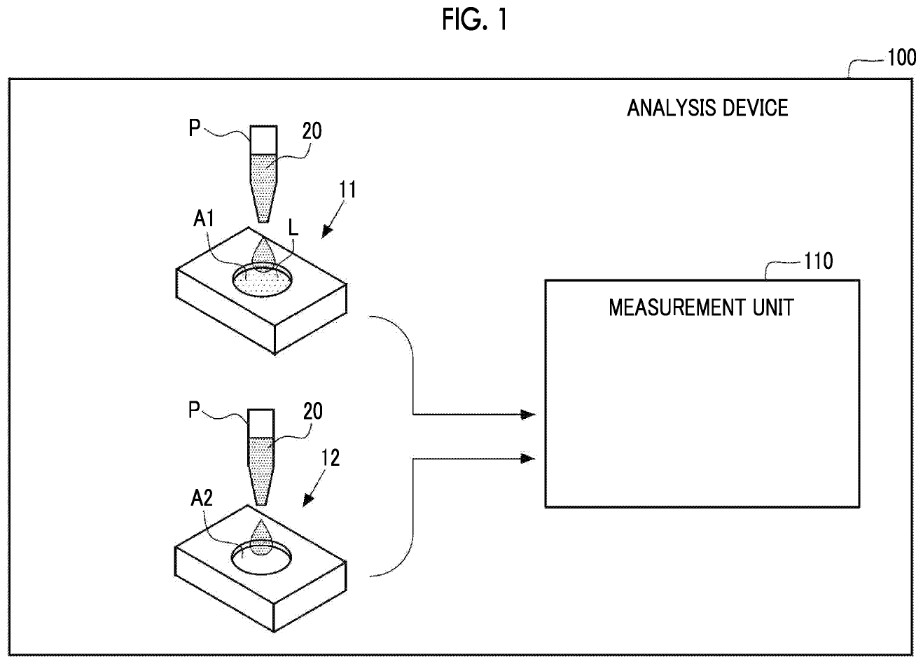

An analysis device 100 according to a first embodiment of the present disclosure illustrated in FIG. 1 is an example of an analysis device that analyzes a sample 20 and that measures the concentration of a substance to be tested which is included in the sample 20, using two analysis chips of a first analysis chip 11 and a second analysis chip 12 as analysis chips. Specifically, the analysis device 100 according to this example uses blood as the sample 20 and optically measures the concentration of the substance to be tested which is included in the blood. More specifically, the sample 20 is, for example, whole blood.

The analysis device 100 includes a dispensing mechanism P and a measurement unit 110. The dispensing mechanism P instills the sample 20 into the first analysis chip 11 and the second analysis chip 12. The measurement unit 110 performs a process of measuring the concentration of the substance to be tested, using the first analysis chip 11 and the second analysis chip 12 into which the sample 20 has already been instilled. For example, the first analysis chip 11 and the second analysis chip 12 are selectively loaded on the measurement unit 110.

In addition, in a case in which it is necessary to wait for a time after the instillation of the sample 20 to perform the measurement, the sample 20 may be instilled before the chip is loaded on the measurement unit 110. The time when the sample is instilled is appropriately determined depending on the type of the sample 20 or the like.

The first analysis chip 11 has a first region A1 that has a reagent L. The second analysis chip 12 has a second region A2 that does not have the reagent L. The reagent L reacts with the substance to be tested to generate a substance that develops a specific color. Hereinafter, the substance that develops a color via this reaction is referred to as a reactant. For example, a dry reagent that is in a dry state at least in a case of shipment is used as the reagent L. The sample 20 is instilled into each of the first region A1 of the first analysis chip 11 and the second region A2 of the second analysis chip 12.

The measurement unit 110 acquires detection signals indicating the optical density of each of the first region A1 and the second region A2, using the first analysis chip 11 and the second analysis chip 12 into which the sample 20 has been instilled. The measurement unit 110 derives the concentration of the substance to be tested which is included in the sample 20 on the basis of the two acquired detection signals.

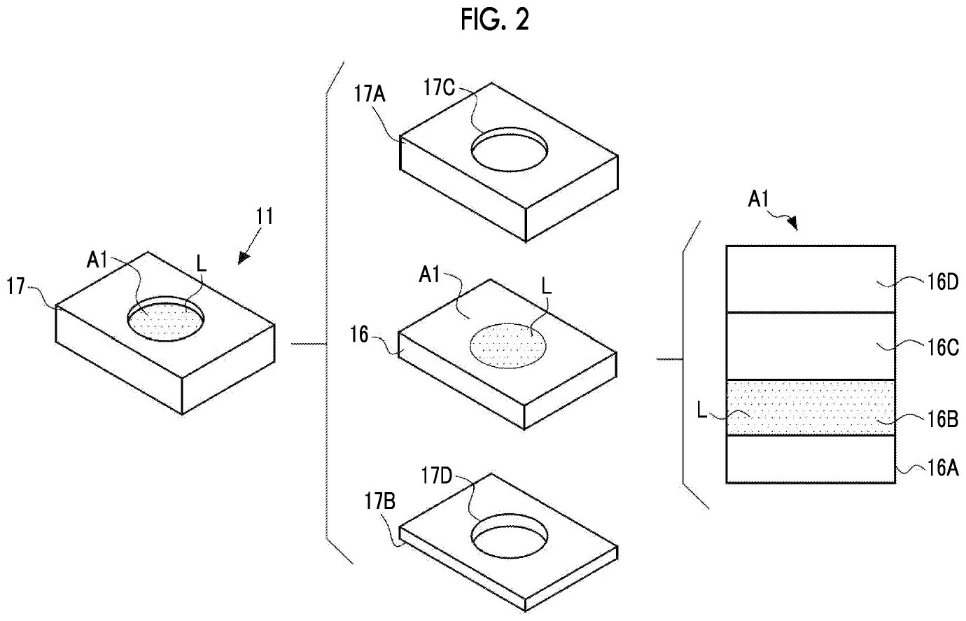

FIG. 2 illustrates a configuration of the first analysis chip 11. As illustrated in FIG. 2, the first analysis chip 11 comprises a carrier 16 into which the sample 20 is instilled and a case 17 which accommodates the carrier 16. The case 17 includes a first case 17A and a second case 17B and accommodates the carrier 16 such that the carrier 16 is interposed between the first case 17A and the second case 17B in a vertical direction in FIG. 2. An opening 17C that functions as a drip opening for instilling the sample 20 into the carrier 16 is formed in the first case 17A. An opening 17D for irradiating the carrier 16 with light is formed in the second case 17B.

The carrier 16 comprises a transparent support 16A, a reaction layer 16B, a reflective layer 16C, and a development layer 16D. In this example, the entire carrier 16 of the first analysis chip 11 is the first region A1. The reaction layer 16B, the reflective layer 16C, and the development layer 16D are stacked in this order from the transparent support 16A. A portion of the transparent support 16A is exposed to the outside of the case 17 through the opening 17D. The transparent support 16A transmits incident light to the reaction layer 16B. The transparent support 16A may not be a completely transparent support having a transmittance of 100% and may transmit at least a portion of the incident light.

Each of the reaction layer 16B, the reflective layer 16C, and the development layer 16D is made of a porous material and has a developing force for developing a liquid with a capillary force and a holding force for holding the developed liquid.

One surface of the development layer 16D is exposed to the outside of the case 17 through the opening 17C. In a case in which the sample 20 is instilled through the opening 17C, the development layer 16D develops the sample 20 in an in-plane direction of the development layer 16D and in a direction toward the reaction layer 16B using the capillary force. The reflective layer 16C is a layer that reflects at least a portion of the incident light. In this example, light is incident from the opening 17D, and the light transmitted through the transparent support 16A is incident on the reaction layer 16B. The reflective layer 16C reflects the light transmitted through the reaction layer 16B to the reaction layer 16B. That is, the reflective layer 16C is provided in order to improve the usage efficiency of the incident light. In addition, the reflective layer 16C is not necessarily needed and may be omitted depending on, for example, the type of the sample 20 or the wavelength of the incident light.

The reaction layer 16B is a layer which can hold the reagent L and in which the reagent L can react with the sample 20 developed from the development layer 16D. In the reaction layer 16B, for example, the reagent L is fixed in a region corresponding to the opening 17D. In this example, the opening 17D has a circular shape, and the region in which the reagent L is fixed is also a circular region that has the same diameter as the opening 17D. Further, the sizes and positions of the opening 17D and the region in which the reagent L is fixed are matched with each other such that the entire region in which the reagent L is fixed is exposed to the outside through the opening 17D.

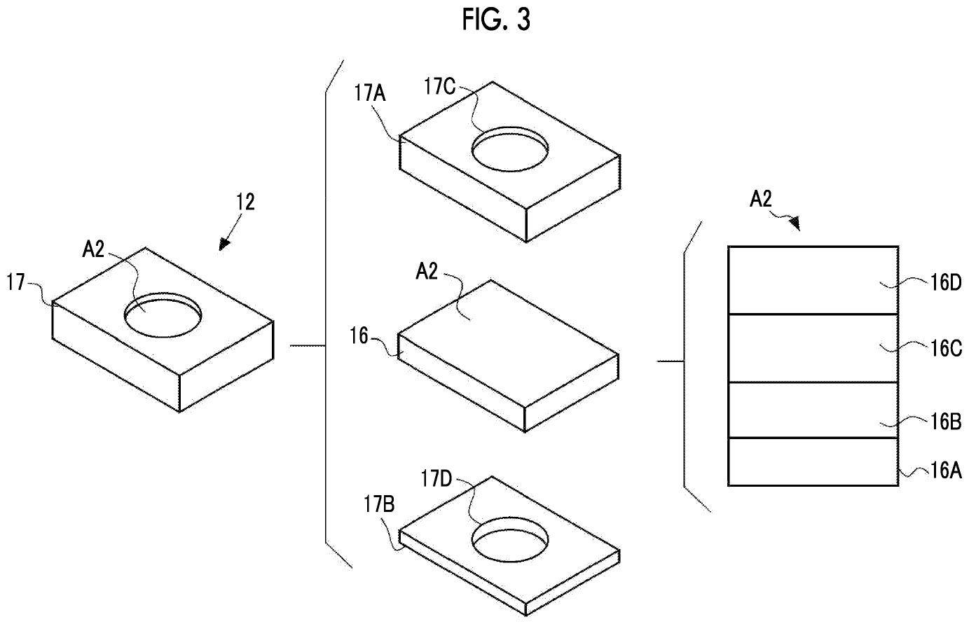

FIG. 3 illustrates a configuration of the second analysis chip 12. As illustrated in FIG. 3, the second analysis chip 12 comprises a carrier 16 into which the sample 20 is instilled and a case 17 that accommodates the carrier 16, similarly to the first analysis chip 11. The carrier 16 and the case 17 have the same configurations as those of the first analysis chip 11.

In this example, the entire carrier 16 of the second analysis chip 12 is the second region A2. The second analysis chip 12 is different from the first analysis chip 11 in that the reaction layer 16B of the carrier 16 is not provided with the reagent L. The second analysis chip 12 is the same as the first analysis chip 11 except that it does not have the reagent L.

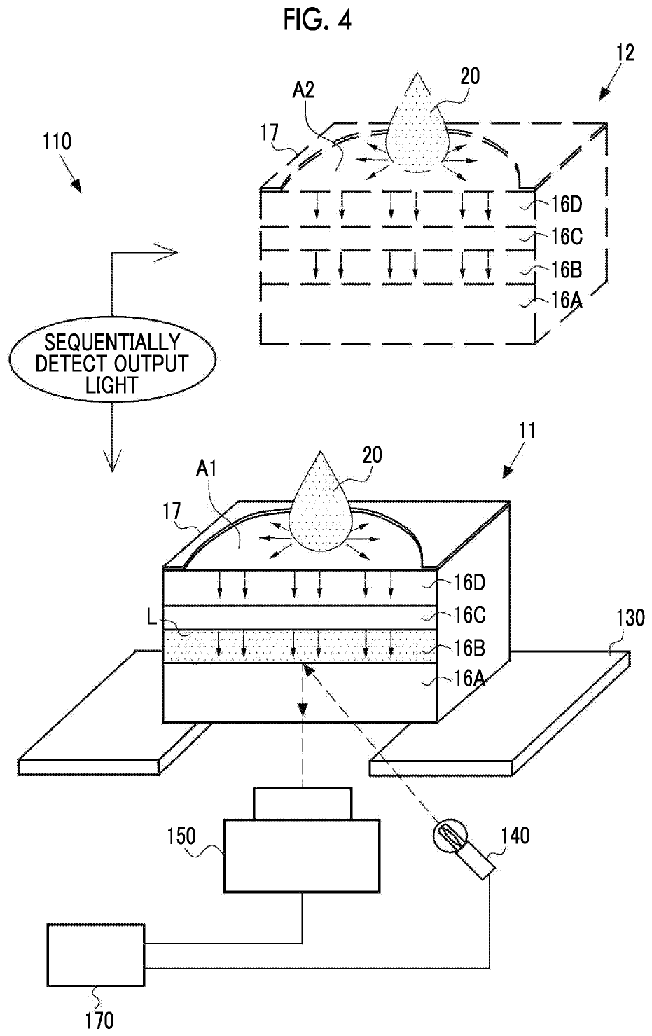

FIG. 4 illustrates a configuration of the measurement unit 110 of the analysis device 100. The measurement unit 110 comprises a loading unit 130, a light source 140, a photodetector 150, and a processor 170. Of the first analysis chip 11 and the second analysis chip 12, the analysis chip to be measured is selectively loaded on the loading unit 130, and the loading unit 130 holds the analysis chip to be measured. FIG. 4 illustrates a state in which the first analysis chip 11 having the reagent L is loaded on the loading unit 130. In addition, in FIG. 4, in the first analysis chip 11 and the second analysis chip 12, while the configuration of the carrier 16 is clearly illustrated, the case 17 is partially omitted and is schematically illustrated.

The light source 140 irradiates the first analysis chip 11 with light. Specifically, the light source 140 irradiates the first region A1 with light through the opening 17D of the case 17 in the first analysis chip 11. The wavelength range of light is determined according to at least one of the substance to be tested, the reagent, or the like. For example, in this example, as described above, a reactant that develops a specific color is generated by the reaction between the substance to be tested and the reagent L. Since the light emitted by the light source 140 is detection light for detecting whether or not a reactant is generated, the wavelength range of the light is determined according to the color developed by the reactant. Since the reactant is generated by the reaction between the substance to be tested and the reagent L, finally, the wavelength range of the detection light emitted by the light source 140 is determined according to at least one of the substance to be tested or the reagent L. Hereinafter, the light emitted by the light source 140 is referred to as detection light. The detection light according to this example is, for example, light that includes a wavelength range absorbed by the reactant in order to detect the reactant.

In particular, it is preferable that the wavelength range of the detection light is limited to the wavelength range absorbed by the reactant. This is because the contrast of the optical density of light in this wavelength range is highest depending on whether the reactant is present or absent. For example, a light source, such as a light emitting diode (LED), an organic electro-luminescence (EL) device, or a semiconductor laser, is used as the light source 140. In addition, a light source that emits light in a relatively broad wavelength range, such as a white light source, may be combined with a bandpass filter that transmits only a specific wavelength range to generate detection light that is limited to a specific wavelength range. Further, in this example, one light source 140 is illustrated. However, a plurality of light sources 140 may be provided as necessary.

In addition, the light source 140 also irradiates the second analysis chip 12 with the detection light. Specifically, the light source 140 irradiates the second region A2 with the detection light through the opening 17D of the case 17 in the second analysis chip 12. The wavelength range of the detection light emitted to the second analysis chip 12 by the light source 140 is the same as the wavelength range of the detection light emitted to the first analysis chip 11.

In a case in which the first analysis chip 11 and the second analysis chip 12 are irradiated with the detection light, the photodetector 150 detects output light that is output from the first analysis chip 11 and the second analysis chip 12.

For example, in a case in which the light source 140 irradiates the first region A1 of the first analysis chip 11 with the detection light, the detection light is transmitted through the transparent support 16A and is incident on the reaction layer 16B. The reaction layer 16B absorbs a portion of the detection light and transmits a portion of the detection light. Specifically, in the reaction layer 16B, a reactant that develops a specific color is generated by the reaction between the reagent L and the substance to be tested. A portion of the detection light incident on the reaction layer 16B is absorbed by the reactant. In addition, a portion of the detection light may be reflected by the reaction layer 16B. At least a portion of the detection light transmitted through the reaction layer 16B is reflected by the reflective layer 16C. In some cases, a portion of the detection light that has reached the development layer 16D is reflected. As described above, a portion of the detection light incident on the first region A1 is reflected in the first region A1, and the reflected light is output from the opening 17D. The reflected light that is output from the first region A1 through the opening 17D is an example of the output light and is hereinafter referred to as first output light.

Similarly, in a case in which the light source 140 irradiates the second region A2 of the second analysis chip with the detection light, a portion of the detection light incident on the second region A2 is reflected by the second region A2, and the reflected light is output from the opening 17D. The reflected light that is output from the second region A2 through the opening 17D is an example of the output light and is hereinafter referred to as second output light.

The photodetector 150 outputs a first detection signal corresponding to the first output light in a case in which the first output light from the first region A1 is detected and outputs a second detection signal corresponding to the second output light in a case in which the output light from the second region A2 is detected. The photodetector 150 outputs the first detection signal and the second detection signal to the processor 170. The photodetector 150 is, for example, a light-receiving element, such as a photodiode, that outputs a detection signal corresponding to the amount of light. The photodetector 150 may not be one light-receiving element and may have a plurality of light-receiving elements.

In the first region A1, the sample 20 and the reagent L react with each other to generate a reactant that develops a specific color. The color of the first region A1 is changed by the generation of the reactant, and the change in the color appears as a change in the optical density of the first region A1. The first output light is output light corresponding to the optical density of the first region A1, and information on the reactant is reflected in the first output light by, for example, the absorption of light by the reactant. The optical density of the first region A1 changes depending on the amount of reactant, and the amount of reactant indicates the concentration of the substance to be tested in the sample 20. Therefore, it is possible to measure the concentration of the substance to be tested on the basis of the first detection signal indicating the first output light including the information on the reactant.

In contrast, in the second region A2, since there is no reagent L, no reactant is generated. Therefore, since the sample 20 is developed in the second region A2, the optical density changes depending on the influence of the sample 20 before and after the instillation of the sample 20. However, since no reactant is generated, the optical density is different from the optical density of the first region A1. The second output light is output light corresponding to the optical density of the second region A2 and does not include the information on the reactant.

As described above, the information on the reactant resulting from the substance to be tested is reflected in the first output light. In addition, information on the other substances is also reflected in the first output light. For example, in a case in which the sample 20 is blood, in addition to information on the substance to be tested included in the blood, information on the other substances is reflected in the first output light. Here, the information on the substances other than the reactant included in the first output light is also included in the second output light. Therefore, for example, it is possible to extract only the information on the reactant resulting from the substance to be tested by subtracting the information included in the second output light from the information included in the first output light.

The processor 170 acquires the first detection signal corresponding to the first output light and the second detection signal corresponding to the second output light and corrects the first detection signal on the basis of the second detection signal. For example, the processor 170 subtracts the second detection signal from the first detection signal to calculate the difference between the two signals or divides the first detection signal by the second detection signal to calculate a ratio between the two signals. The processor 170 derives the concentration of the substance to be tested on the basis of the first detection signal corrected in this way. That is, the processor 170 uses the second detection signal as a reference signal to be referred to as a reference and corrects the first detection signal, using the second detection signal as the reference signal.

The processor 170 includes, for example, a CPU and a memory, and the CPU executes a program to perform a process of deriving the concentration of the substance to be tested. In addition, the processor 170 controls the overall operation of each unit of the measurement unit 110.

Further, in the example illustrated in FIG. 4, the photodetector 150 is disposed at a position that faces the opening 17D of the case 17 of the first or second analysis chip 11 or 12 loaded on the loading unit 130. Furthermore, the light source 140 is disposed at a position where the detection light is emitted in an oblique direction with respect to the opening 17D. This layout of the photodetector 150 and of the light source 140 is an example, and various modifications can be made. For example, in a case in which a light guide member that guides the detection light or the output light between the opening 17D, and the photodetector 150 and the light source 140 is used, the photodetector 150 and the light source 140 can be moved to various positions.

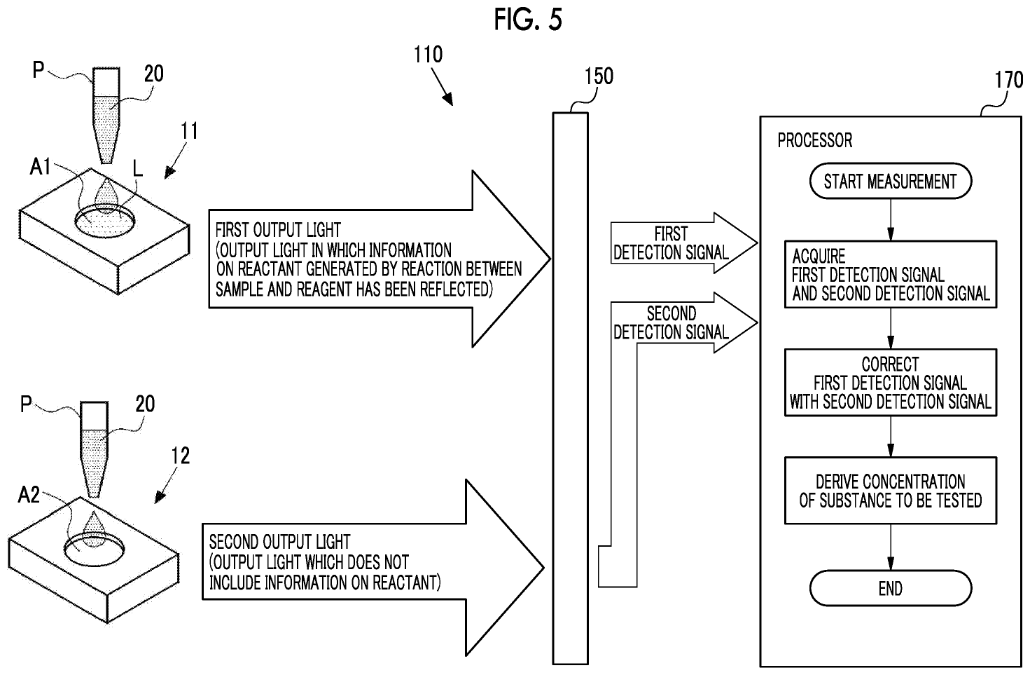

FIG. 5 illustrates a processing procedure of a measurement process of the measurement unit 110 of the analysis device 100 according to the first embodiment. First, the sample 20 is instilled into each of the first analysis chip 11 and the second analysis chip 12 by the dispensing mechanism P. The first analysis chip 11 and the second analysis chip 12 into which the sample 20 has been instilled are selectively loaded on the measurement unit 110. The measurement unit 110 sequentially detects the output light using the loaded first analysis chip 11 or second analysis chip 12. For example, the first analysis chip 11 is loaded first, and then the second analysis chip 12 is loaded. After the first analysis chip 11 is loaded on the measurement unit 110, the light source 140 irradiates the first analysis chip 11 with the detection light. In a case in which the detection light is emitted, the first output light is output from the first region A1 of the first analysis chip 11. The photodetector 150 detects the first output light and outputs the first detection signal corresponding to the first output light. The processor 170 acquires the first detection signal.

Then, after the second analysis chip 12 is loaded on the measurement unit 110, the light source 140 irradiates the second analysis chip 12 with the detection light. In a case in which the detection light is emitted, the second output light is output from the second region A2 of the second analysis chip 12. The photodetector 150 detects the second output light and outputs the second detection signal corresponding to the second output light. The processor 170 acquires the second detection signal.

As described above, the analysis device 100 performs a step of using the first analysis chip 11 and the second analysis chip 12 having two regions of the first region A1, which has the reagent L reacting with the substance to be tested, and the second region A2, which does not have the reagent L, respectively, and irradiating the first analysis chip 11 and the second analysis chip 12 with light from the light source 140. Then, the processor 170 performs a step of directing the photodetector 150 to detect the first output light and the second output light which are output from the first analysis chip 11 and the second analysis chip 12, respectively, in a case in which the first analysis chip 11 and the second analysis chip 12 are irradiated with light and acquiring the first detection signal corresponding to the first output light from the first region A1 and the second detection signal corresponding to the second output light from the second region A2 which are output by the photodetector 150.

The first detection signal is a signal corresponding to the first output light in which the information on the reactant has been reflected, and the second detection signal is a signal corresponding to the second output light which does not include the information on the reactant. The processor 170 performs a step of correcting the first detection signal with the second detection signal and deriving the concentration of the substance to be tested on the basis of the corrected first detection signal. In this way, the process of measuring the concentration of the substance to be tested included in the sample 20 ends.

As described above, the processor 170 corrects the first detection signal including the information on the reactant, using the second detection signal that does not include the information on the reactant as the reference signal. Therefore, it is possible to remove the information on substances other than the reactant from the first detection signal. As a result, in a case in which the sample 20 is analyzed using the analysis chip, it is possible to measure the concentration of the substance to be tested in the sample 20 with higher accuracy than that in the related art. For example, in a case in which whole blood is used as the sample 20, the first detection signal is a signal including all of the information on substances other than the substance to be tested included in the whole blood, in addition to the information on the reactant. However, the use of the second detection signal that does not include the information on the reactant as the reference signal makes it possible to extract the information on only the substance to be tested from the first detection signal. Therefore, even in a case in which the analysis chip is used, it is possible to increase the accuracy of measuring the concentration as compared to the related art.

In this example, whole blood is described as an example of the sample 20. However, the sample 20 may be blood plasma or blood serum. The blood plasma or the blood serum also includes substances other than the substance to be tested. According to the technology of the present disclosure, it is possible to remove the information on substances other than the substance to be tested.

In addition, in this example, the wavelength ranges of the light emitted to the first region A1 and to the second region A2 are the same. However, the wavelength ranges may not be completely the same.

In addition, since two analysis chips of the first analysis chip 11 and the second analysis chip 12 are used, it is possible to reduce the mutual influence of the first detection signal from the first region A1 and the second detection signal from the second region A2 which causes noise. This makes it possible to further increase the accuracy of measuring the concentration.

In addition, each of the first analysis chip 11 and the second analysis chip 12 comprises the carrier 16 including the development layer 16D in which the sample 20 is developed and the reaction layer 16B which can hold the reagent L and in which the reagent L and the substance to be tested can react with each other. Since the configuration of the carrier 16 is the same as that of the carrier of the analysis chip according to the related art, it is easy to use the analysis chip according to the related art. Further, it is possible to reduce the manufacturing costs of the first analysis chip 11 and the second analysis chip 12.

In addition, since the loading unit 130 on which the first analysis chip 11 and the second analysis chip 12 are selectively loaded is provided, it is easy to use the configuration of the analysis device according to the related art, as compared to a case in which a plurality of loading units are provided.

### Second Embodiment

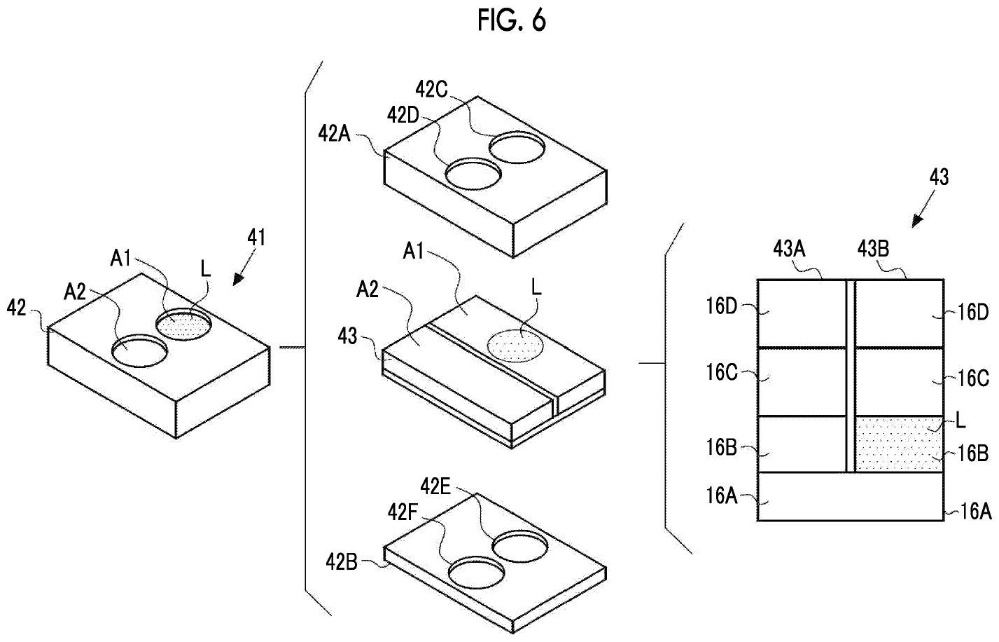

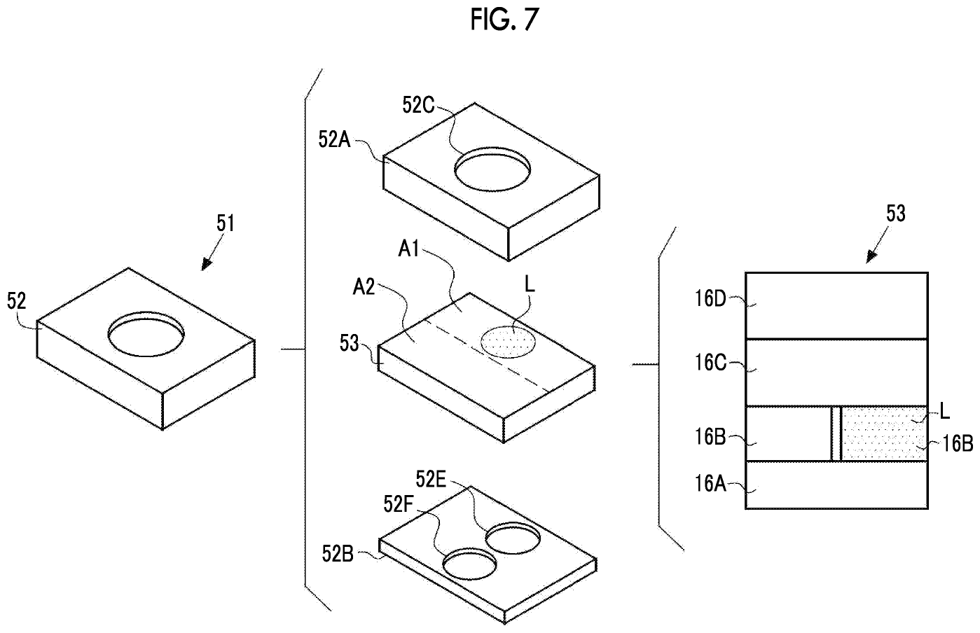

The first embodiment is an example in which two analysis chips of the first analysis chip 11 having the first region A1 and the second analysis chip 12 having the second region A2 are used. However, a second embodiment illustrated in FIGS. 6 and 7 is an example in which a single analysis chip 41 having the first region A1 and the second region A2 is used as the analysis chip. In addition, the same configurations as those described above are denoted by the same reference numerals, the difference from the first embodiment will be mainly described, and duplicate description will be omitted.

As illustrated in FIG. 6, the analysis chip 41 used in the second embodiment has two regions of the first region A1 that has the reagent L and the second region A2 that does not have the reagent L. The analysis chip 41 includes a carrier 43 into which the sample 20 is instilled and a case 42 that accommodates the carrier 43. The case 42 includes a first case 42A and a second case 42B and accommodates the carrier 43 to be interposed between the first case 42A and the second case 42B in the vertical direction in FIG. 6.

The carrier 43 has two regions of the first region A1 that has the reagent L and the second region A2 that does not have the reagent L. The carrier 43 is divided into a first portion 43A and a second portion 43B. The first portion 43A is the first region A1, and the second portion 43B is the second region A2. In this example, the carrier 43 has a rectangular shape in a plan view. The carrier 43 is divided into two portions by a straight line along a longitudinal direction of the carrier 43. As a result, two elongated portions of the first portion 43A and the second portion 43B are provided.

Each of the first portion 43A and the second portion 43B has a stacked structure of the transparent support 16A, the reaction layer 16B, the reflective layer 16C, and the development layer 16D, similarly to the carrier 16 according to the first embodiment illustrated in FIGS. 2 and 3. Among these layers, only the transparent support 16A has a single structure and is shared by both the first portion 43A and the second portion 43B. The other layers of the reaction layer 16B, the reflective layer 16C, and the development layer 16D are divided into the first portion 43A and the second portion 43B and are configured as separate layers. The reaction layer 16B, the reflective layer 16C, and the development layer 16D in the first portion 43A are a first reaction layer, a first reflective layer, and a first development layer according to the technology of the present disclosure, respectively. The reaction layer 16B, the reflective layer 16C, and the development layer 16D in the second portion 43B are a second reaction layer, a second reflective layer, and a second development layer according to the technology of the present disclosure, respectively.

Openings 42C and 42D for instilling the sample 20 into the carrier 43 are formed in the first case 42A. The opening 42C is an opening which functions as a drip opening for instilling the sample 20 into the first region A1 and through which a portion of the development layer 16D in the first region A1 is exposed to the outside. The opening 42D is an opening which is used to instill the sample 20 into the second region A2 and through which a portion of the development layer 16D in the second region A2 is exposed to the outside.

Openings 42E and 42F for irradiating the carrier 43 with light are formed in the second case 42B. The opening 42E is an opening for irradiating the first region A1 with the detection light and taking out the first output light, and the opening 42F is an opening for irradiating the second region A2 with the detection light and taking out the second output light.

Further, for example, a light shielding member that prevents light from mutually entering the first portion 43A and the second portion 43B is provided between the first portion 43A and the second portion 43B, which is not illustrated. Therefore, the detection light emitted from the light source 140 is incident only on the first region A1 through the opening 42E, and only the information on the first region A1 is reflected in the first output light that is output from the opening 42E. Further, the detection light emitted from the light source 140 is incident only on the second region A2 through the opening 42F, and only the information on the second region A2 is reflected in the second output light that is output from the opening 42F.

In the analysis device 100 using the analysis chip 41 according to the second embodiment, a measurement unit 110 has the same configuration as that in the first embodiment. Of course, for example, the layout of the light source 140 and of the photodetector 150 may be changed depending on the form of the analysis chip 41.

In a case in which the analysis chip 41 is used, the measurement unit 110 selectively irradiates the first region A1 and the second region A2 with the detection light from the light source 140 and detects the first output light and the second output light selectively output from the analysis chip 41 with the photodetector 150. The photodetector 150 outputs the first detection signal and the second detection signal to the processor 170. The process of the processor 170 is the same as that in the first embodiment.

In the second embodiment, the single analysis chip 41 having the first region A1 and the second region A2 is used as the analysis chip, which makes it possible to perform one test with one analysis chip. Since the analysis chip is a consumable item, it is possible to reduce test costs, as compared to a case in which a plurality of analysis chips are used.

In addition, it is not necessary to replace a plurality of analysis chips since one analysis chip is used. Therefore, it is also possible to reduce the processing time and labor required for replacement.

Further, for the reaction layer of the analysis chip 41, the reaction layer 16B corresponding to the first region A1 (an example of the first reaction layer) and the reaction layer 16B corresponding to the second region A2 (an example of the second reaction layer) are separate layers. Therefore, it is possible to reduce the mutual influence of the detection signals between the first region A1 and the second region A2. Furthermore, since the development layer 16D corresponding to the first region A1 (an example of the first development layer) and the development layer 16D corresponding to the second region A2 (an example of the second development layer) are also separate layers, the mutual entry of the sample 20 developed in each of the first region A1 and the second region A2 is suppressed. Therefore, it is easy to control the amount of development of the sample 20 in each of the regions A1 and A2. As a result, it is possible to further reduce the mutual influence of the detection signals.

Modification Example of Second Embodiment

In addition, an analysis chip 51 illustrated in FIG. 7 may be used as a modification example of the analysis chip 41 illustrated in FIG. 6. A carrier 53 of the analysis chip 51 has the first region A1 and the second region A2. In the carrier 53, only the reaction layer 16B that holds the reagent L is divided into the first region A1 and the second region A2. In addition to the transparent support 16A, the reflective layer 16C and the development layer 16D are single layers that are common to the first region A1 and to the second region A2.

In the analysis chip 51, a case 52 that accommodates the carrier 53 includes a first case 52A and a second case 52B. The first case 52A is provided with an opening 52C that functions as a drip opening for instilling the sample 20. The opening 52C is common to the first region A1 and to the second region A2. The second case 52B is provided with openings 52E and 52F. The opening 52E is an opening for irradiating the first region A1 with the detection light and taking out the first output light. The opening 52F is an opening for irradiating the second region A2 with the detection light and taking out the second output light.

In the analysis chip 51, the development layer 16D is also a single development layer that is common to the first region A1 and to the second region A2. Therefore, it is possible to further simplify the configuration of the analysis chip. Further, in the analysis chip 51, in addition to the development layer 16D, the reflective layer 16C is also a single reflective layer that is common to the first region A1 and to the second region A2. Therefore, it is possible to further simplify the configuration of the analysis chip.

Image Sensor

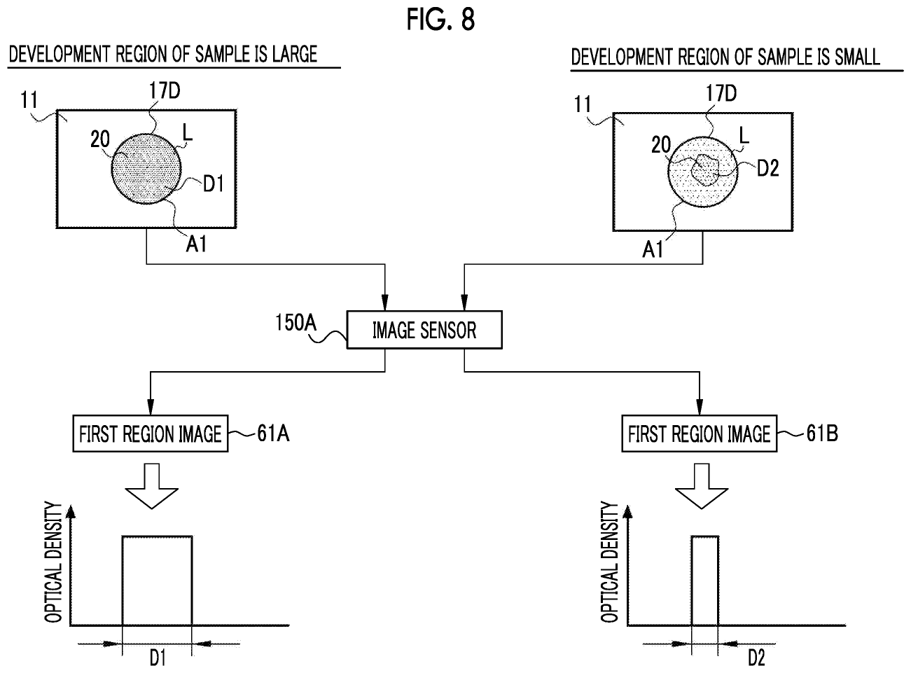

The example in which a photodiode is used as the photodetector 150 has been described above. However, as illustrated in FIG. 8, an image sensor 150A having an imaging surface in which a plurality of light-receiving elements are two-dimensionally arranged may be used as the photodetector 150. The following effects are obtained by this configuration.

In a case in which the sample 20 is developed in the first region A1 of the analysis chip 11, the area of a development region may change depending on the development state of the sample 20. In FIG. 8, in a development region D1 on a left side, the sample 20 is developed in substantially the entire first region A1 exposed through the opening 17D. On the other hand, in a development region D2 on a right side, the sample 20 is not developed in the entire first region A1. The development region D2 has a smaller area than the development region D1.

In this case, for example, a photodiode composed of a single light-receiving element does not have a spatial resolution for identifying the development region and the other regions. Therefore, the first detection signal output by the photodiode has a value obtained by averaging the optical densities of the development region and the other regions. Therefore, in a case in which the area of the development region is small, the optical density indicated by the first detection signal output from the photodiode is reduced due to the influence of a non-development region. For example, in the example illustrated in FIG. 8, a case is considered in which the optical densities of the development region D1 and the development region D2 are the same on the premise that the optical density of the development region D2 is higher than the optical density of the other regions. In this case, the amount of output light from the first region A1 on the right side in FIG. 8 which has the relatively small development region D2 is larger than the amount of output light from the first region A1 on the left side which has the relatively large development region D1 due to the influence of a region having a low optical density other than the development region D2.

In a case in which the image sensor 150A is used as the photodetector 150 as illustrated in FIG. 8, it is possible to solve the above-mentioned problems. The image sensor 150A is, for example, a complementary metal oxide semiconductor (CMOS) image sensor or a charge coupled device (CCD) image sensor and has an imaging surface in which a plurality of light-receiving elements are two-dimensionally arranged. Therefore, the image sensor 150A has a spatial resolution unlike the photodiode. Therefore, the image sensor 150A can image the first region A1 to identify a development region D, such as the development regions D1 and D2, and the other regions.

The image sensor 150A can output a first region image 61 obtained by imaging the first region A1, such as a first region image 61A and a first region image 61B illustrated in FIG. 8, as the first detection signal. The processor 170 identifies the development region D in which the sample 20 has been developed and the other regions in the first region A1 on the basis of the first region image 61 and corrects the first detection signal according to the development region D. The processor 170 performs image analysis, such as contour extraction, on the basis of the first region image 61 to extract the development region D. Then, the processor 170 corrects the first detection signal indicating the optical density of the first region A1 according to the development region D. For example, in a case in which the processor 170 acquires the first region image 61A obtained by imaging the first region A1 including the development region D1 on the left side in FIG. 8 as the first region image 61, the optical density of the first region A1 is determined using the pixel values of the entire first region A1 since the entire first region A1 exposed through the opening 17D is the development region D1. On the other hand, in a case in which the processor 170 acquires the first region image 61B obtained by imaging the first region A1 including the development region D2 on the right side in FIG. 8, the optical density of the first region A1 is determined using the pixel values of only the development region D2 since a portion of the first region A1 is the development region D2.

As described above, the processor 170 identifies the development region D, in which the sample 20 has been developed, in the first region A1 on the basis of the first region image 61 acquired from the image sensor 150A and corrects the first detection signal according to the development region D. Therefore, even in a case in which the development region D is different, it is possible to accurately understand the optical density of the first region A1. As a result, it is possible to further increase the accuracy of measuring the concentration of the substance to be tested.

In addition, as described above, the wavelength range of the light emitted from the light source 140 to the first region A1 includes a specific wavelength range that is determined according to at least one of the substance to be tested or the reagent.

Further, a light source that can emit light in a plurality of different wavelength ranges as the light in the specific wavelength range may be used as the light source 140.

As the light source 140 that can emit light in a plurality of wavelength ranges, a plurality of light sources that can emit light in different wavelength ranges may be combined. For example, a light source having a broad wavelength range, such as a halogen lamp, and a plurality of bandpass filters that pass light in different wavelength ranges may be combined to cut out light in different wavelength ranges.

In addition, in the above-described embodiment, the example in which a dry reagent is used as the reagent L has been described. However, the reagent L may not be the dry reagent and may be a liquid reagent. Further, the reagent L may not be fixed in the carrier in a case in which the analysis chip is manufactured and may be instilled into the first region A1 by the dispensing mechanism P immediately before the measurement, similarly to the sample 20.

Furthermore, in the above-described embodiment, blood has been described as an example of the sample 20. However, the sample 20 may not be blood, and the technology of the present disclosure can be applied to a biological substance other than blood.

In addition, in the above-described embodiment, the reflected light has been described as an example of the output light. However, the output light may be transmitted light that is transmitted through the carrier of the analysis chip and then output.

Further, in the above-described embodiment, the following various processors can be used as a hardware structure of the processor. The various processors include, for example, a CPU which is a general-purpose processor executing software (programs) to function as various processing units, a programmable logic device (PLD), such as a field-programmable gate array (FPGA), whose circuit configuration can be changed after manufacture, and a dedicated electric circuit, such as an application specific integrated circuit (ASIC), which is a processor having a dedicated circuit configuration designed to perform a specific process.

In addition, the above-described processes may be performed by one of the various processors or by a combination of two or more processors of the same type or different types (for example, a combination of a plurality of FPGAs and a combination of a CPU and an FPGA). Further, a plurality of processing units may be configured by one processor. An example in which a plurality of processing units are configured by one processor is an aspect in which a processor that implements the functions of the entire system including a plurality of processing units using one integrated circuit (IC) chip is used, such as a system-on-chip (SOC).

In addition, specifically, an electric circuit (circuitry) obtained by combining circuit elements, such as semiconductor elements, can be used as the hardware structure of these processors.

Further, the technology of the present disclosure is applied to a computer-readable storage medium (for example, a USB memory or a digital versatile disc (DVD)-read only memory (ROM)) that stores an operation program of the analysis device in a non-transitory manner, in addition to the operation program of the analysis device.

In addition, the above descriptions and illustrations are detailed descriptions of portions related to the technology of the present disclosure and are merely examples of the technology of the present disclosure. For example, the above description of the configurations, functions, operations, and effects is the description of examples of the configurations, functions, operations, and effects of portions according to the technology of the present disclosure. Therefore, it goes without saying that unnecessary portions may be deleted or new elements may be added or replaced in the above descriptions and illustrations without departing from the gist of the technology of the present disclosure. In addition, in the content described and illustrated above, the description of, for example, common technical knowledge that does not need to be particularly described to enable the implementation of the technology of the present disclosure is omitted in order to avoid confusion and to facilitate the understanding of portions related to the technology of the present disclosure.

All of the documents, the patent applications, and the technical standards described in the specification are incorporated by reference herein to the same extent as each individual document, each patent application, and each technical standard are specifically and individually stated to be incorporated by reference.

What is claimed is:

1. An analysis device that analyzes a sample including a substance to be tested and that uses a single or a plurality of analysis chips having two regions of a first region, which has a reagent reacting with the substance to be tested, and a second region, which does not have the reagent, the analysis device comprising:
a light source that irradiates the analysis chip with light;
a photodetector that detects output light, which is output from the analysis chip in a case in which the analysis chip is irradiated with the light, and that outputs a first detection signal corresponding to the output light from the first region and a second detection signal corresponding to the output light from the second region; and
a processor that is configured to acquire the first detection signal and the second detection signal from the photodetector, and correct the first detection signal with the second detection signal to derive a concentration of the substance to be tested included in the sample.

2. The analysis device according to claim 1,
wherein two analysis chips of a first analysis chip having the first region and a second analysis chip having the second region are used as the analysis chip.

3. The analysis device according to claim 2,
wherein each of the first analysis chip and the second analysis chip includes a carrier having a development layer in which the sample is developed and a reaction layer which is capable of holding the reagent and in which the reagent and the substance to be tested are capable of reacting with each other.

4. The analysis device according to claim 2, further comprising:
a loading unit on which the first analysis chip and the second analysis chip are selectively loaded.

5. The analysis device according to claim 1,
wherein the single analysis chip having the first region and the second region is used as the analysis chip.

6. The analysis device according to claim 5,
wherein the single analysis chip includes a development layer in which the sample is developed and a reaction layer which is capable of holding the reagent and in which the reagent and the substance to be tested are capable of reacting with each other, and
the reaction layer has a first reaction layer which corresponds to the first region having the reagent and a second reaction layer which corresponds to the second region that does not have the reagent and which is separate from the first reaction layer.

7. The analysis device according to claim 6,
wherein the development layer has a first development layer which corresponds to the first region and a second development layer which corresponds to the second region and which is separate from the first development layer.

8. The analysis device according to claim 6,
wherein the development layer is a single development layer that is common to the first region and to the second region.

9. The analysis device according to claim 1,
wherein the output light is light which has been emitted from the light source and reflected by the first region or the second region.

10. The analysis device according to claim 1,
wherein the photodetector is an image sensor that has an imaging surface in which a plurality of light-receiving elements are two-dimensionally arranged and that is capable of imaging the first region and outputting a first region image obtained by imaging the first region as the first detection signal, and
the processor is configured to identify a development region in which the sample has been developed in the first region on the basis of the first region image and correct the first detection signal according to the development region.

11. The analysis device according to claim 10,
wherein a wavelength range of light emitted from the light source to the first region includes a specific wavelength range that is determined according to at least one of the substance to be tested or the reagent.

12. The analysis device according to claim 11,
wherein the light source is capable of emitting light in a plurality of different wavelength ranges as the light in the specific wavelength range.

13. The analysis device according to claim 1,
wherein the reagent is a dry reagent.

14. The analysis device according to claim 1,
wherein the sample is whole blood, and
the substance to be tested is a specific substance included in blood plasma or in blood serum.

15. An analysis method for analyzing a sample including a substance to be tested, a single or a plurality of analysis chips having two regions of a first region and a second region being used, the first region having a reagent reacting with the substance to be tested, and the second region not having the reagent, the analysis method comprising:
a step of irradiating the analysis chip with light from a light source;
a step of detecting output light, which is output from the analysis chip in a case in which the analysis chip is irradiated with the light, with a photodetector and acquiring a first detection signal and a second detection signal output by the photodetector, the first detection signal corresponding to the output light from the first region, and the second detection signal corresponding to the output light from the second region; and
a step of correcting the first detection signal with the second detection signal with a processor to derive a concentration of the substance to be tested included in the sample.
